(19) United States
(12) Patent Application Publication
(10) Pub. No.: US 2023/0004122 A1
(43) Pub. Date: Jan. 5, 2023

(54) Nmotion Watches

(71) Applicant: Darnell Michael Bond-Awls, Woodstock, GA (US)

(72) Inventor: Darnell Michael Bond-Awls, Woodstock, GA (US)

(21) Appl. No.: 17/366,050

(22) Filed: Jul. 2, 2021

(51) Int. Cl. G04B 19/20; G04B 37/00; G04B 45/00

(52) U.S. Cl. CPC G04B 19/207; G04B 37/0058; G04B 45/0069

(57) ABSTRACT

The current invention proposes an improved combination of bracelet and wrist watch comprising a band with watch body where each part defines seconds, minutes and hours. The body is unique and pleasing thus making it suitable for everyone's usage.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### BACKGROUND

### Field of the Invention

The present invention relates to a wrist watch and particularly to a bracelet type wrist watch which is designed to wear around the wrist as an ornament.

### Description of the Related Art

Wristwatches have long been designed as jewelry items for adornment of the wrist as well as for their functional timekeeping capability. However, there may be times when adornment is the paramount consideration and it is desired to exhibit a decorative design, precious stones or the like, rather than the face of a timepiece.

Small watches are designed to be worn around the wrist by using leather straps, synthetic resin or metal bands in the form of bracelets. Otherwise, watches are designed to be worn around the neck by using chains or straps in the form of a hanging ornament or pendant, or around the ring finger by using circles. Among these different types of wrist watches customers take their choice to fit their suits or dresses. Thus, there are two different aspects of the wrist watch: an instrument for measuring and showing time, and at the same time, an ornament or accessory matching a dress or suit.

Recently the role of the wrist watch as an ornament has become more important than the role of the wrist watch as an instrument for measuring and showing time. There has been an ever-increasing demand for unique ornamental design.

Reversible wristwatches are known in the prior art. One such reversible wristwatch is disclosed in Swiss Pat. No. 138929—Schierwater published Jun. 2, 1930 in which a watch case is rotatable about two diametrically opposed pins by means of a strap attachment connected to a collar. This permits protection of the crystal while engaged in sports. However, since the strap attachment conforms to the curvature of the watch, either a spring or an expansion band is provided to give necessary slack to rotate the watch. The patent refers to a caseback which may be ornamental, fitted with a medallion, or having a coat of enamel carrying a decorative motif on the surface of the caseback.

Another such reversible wristwatch is disclosed in U.S. Pat. No. 4,493,561, issued Jan. 15, 1985 Bouchet, in which the watch case is rotatably mounted its 6 o'clock-noon axis on two bars perpendicular to the axis, each of the bars being attached to respective opposite ends of a watch strap. Although this wristwatch is primarily intended for two movements and/or two opposed dials each viewable through crystals on opposite sides of the bezel, it suggests that the case might contain only one movement which would be visible from one side of the case only, the other side or bottom of the case being provided with precious or semi-precious stones.

Still another reversible watch with a decorative back such as an engraved monogram, but with attachment suitable for a leather strap, is shown in French patent application 79 02771 filed Feb. 2, 1979 and published as No. 1 447 692 on Aug. 29, 1980.

There are multiple inventions that have been proposed in prior art regarding bringing an advancement and enhanced utility in case of bracelets and wrist watches combination. Furthermore, the utilization of these systems in daily life are quite cumbersome and non-effective. Also, the features of these utility system are quite limited.

The instant invention attempts to overcome deficiencies of the prior art by providing a by providing a wrist watch of unique ornamental design, while still assuring the ease with which the wrist watch can be worn around the wrist.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is related to an advancement in offering a wrist watch of unique ornamental design, while still assuring the ease with which the wrist watch can be worn around the wrist.

It is further the objective of the invention to provide a wrist watch which looks like a bracelet, permitting the face of the wrist watch to appear when desired

It is moreover the objective of the invention to provide a provide an improved case back for holding a decorative insert for such a wristwatch.

It is a further object of the present invention to provide a new and improved assembly which is of a durable and reliable construction.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows anterior view of claimed assembly as per preferred embodiments of the invention.

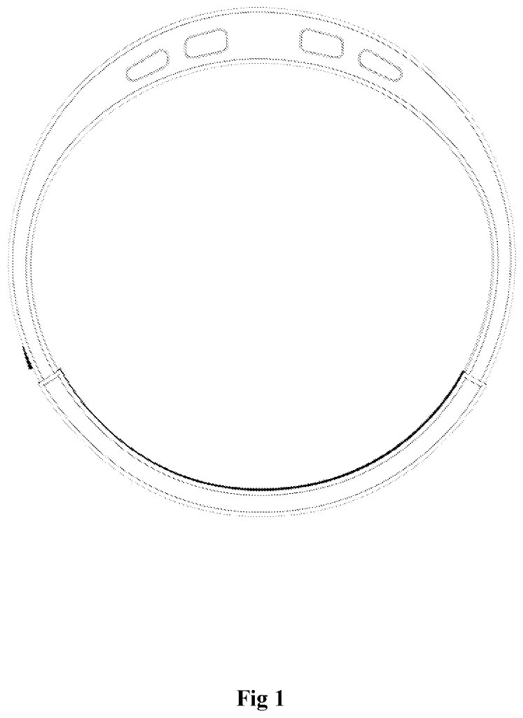

FIG. 2 shows front view of claimed assembly as per preferred embodiments of the invention.

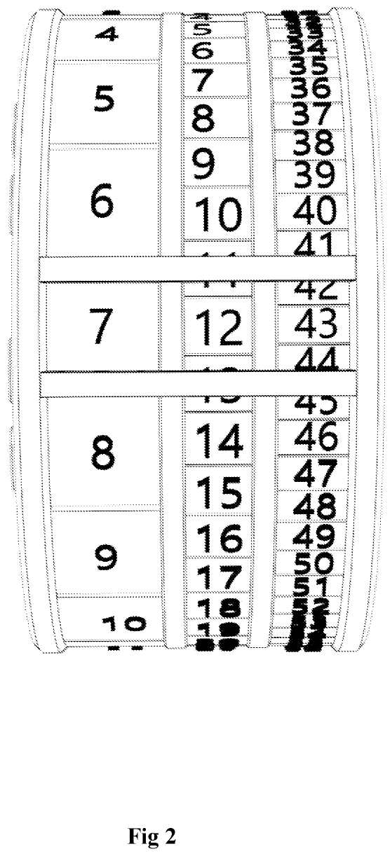

FIG. 3 shows side view of claimed assembly as per preferred embodiments of the invention.

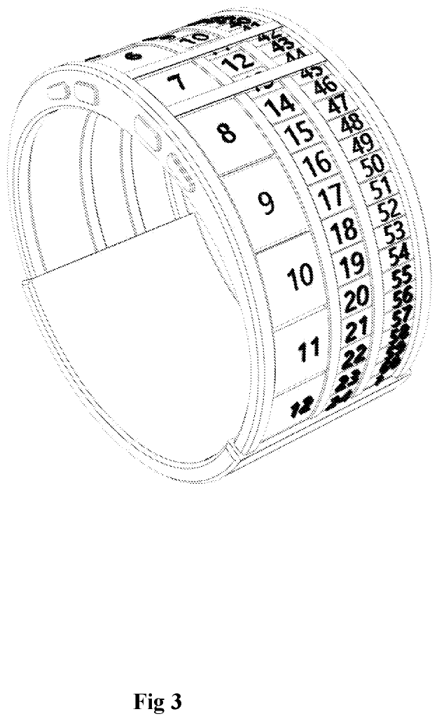

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

More specifically, the present invention as per its preferred embodiments is a new approach towards creation of a bracelet type watch which is not only aesthetically pleasing but unique in design as well.

The invention as per its preferred embodiments is a watch designed in for of a bracelet where the seconds constantly move around the wrist to match the time. All belts of watch move individually as a whole. The assembly is formed in combination of leather and glass with multiple color schemes. However, the material cannot be limited in any way.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1: An architecture of watch and bracelet comprising:
a watch including a band, glass, and a back defining an enclosure;
a movement disposed in said enclosure;
said back defining a recessed well on exterior thereof, and having a decorative insert disposed in said well and;
a bracelet shaped body.
